(19) United States
(12) Patent Application Publication
(10) Pub. No.: US 2025/0062641 A1
(43) Pub. Date: Feb. 20, 2025

(54) Wireless Charging Table for an Aircraft

(71) Applicant: Textron Aviation Inc., Wichita, KS (US)

(72) Inventors: Patrick Allen Stanton, Rose Hill, KS (US); Priyadarshini Talreja, Wichita, KS (US)

(21) Appl. No.: 18/798,433

(22) Filed: Aug. 8, 2024

Related U.S. Application Data
(60) Provisional application No. 63/519,926, filed on Aug. 16, 2023.

(51) Int. Cl. H02J 50/00; B64D 11/06; H01R 13/24; H02J 7/00

(52) U.S. Cl. CPC H02J 50/005; B64D 11/0638; H01R 13/24; H02J 7/0044; B64D 2221/00; H02J 2310/44

(57) ABSTRACT

A wireless charging table for use in an aircraft includes a frame assembly for mounting the wireless charging table within the aircraft; a table leaf support coupled to the frame assembly and maneuverable between a stowed position and a deployed position; a main table leaf mounted to the table leaf support and having a power unit; and an electrical system to provide power to the power unit when the table leaf support is in the deployed position. When the table leaf support is in the deployed position, an electrical connection is established between a power source and the power unit, and when the table leaf support is in the stowed position, the electrical connection is broken between the power source and the power unit. The power unit is to provide wireless charging to one or more devices when the electrical connection is established.

### CROSS-REFERENCE TO RELATED APPLICATIONS

This application claims the benefit of priority of U.S. Provisional Patent No. 63/519,926 filed on Aug. 16, 2023, the entire contents of which are herein incorporated by reference.

### BACKGROUND

### 1. Field

Embodiments of the disclosure relate to aircraft tables, and in particular to a fold-out side ledge wireless charging table for an aircraft that is configured to provide power and charging when in a deployed position and disconnect power when in a stowed position.

### 2. Related Art

Aircraft tables are well known in the art and include both seatback trays, as well as side tables. Many of these tables are conventionally configured to have both a deployed position and a stowed position, such that the tables may be stowed or folded away when not in use. For example, U.S. Pat. No. 6,489,745B1 to Koreis describes an aircraft seatback tray with a contactless power supply. U.S. Pat. No. 8,528,968B2 to Moulton et al. describes a side table tray as part of an aircraft system, the tray having both stowed and deployed configurations.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In embodiments, the disclosure relates to a wireless charging table for use in an aircraft. The wireless charging table includes a frame assembly for mounting the wireless charging table within the aircraft; a table leaf support coupled to the frame assembly and maneuverable between a stowed position and a deployed position; a main table leaf mounted to the table leaf support and having a power unit; and an electrical system configured to provide power to the power unit when the table leaf support is in the deployed position. When the table leaf support is in the deployed position, an electrical connection is established between a power source and the power unit and when the table leaf support is in the stowed position, the electrical connection is broken between the power source and the power unit. The power unit is configured to provide wireless charging to one or more devices when the electrical connection is established.

In other embodiments, the disclosure relates to a method of charging a device on an aircraft. The method includes first providing a wireless charging table having a frame assembly for mounting the wireless charging table within the aircraft; a table leaf support coupled to the frame assembly and maneuverable between a stowed position and a deployed position; a main table leaf mounted to the table leaf support and having a power unit; and an electrical system configured to provide power to the power unit when the table leaf support is in the deployed position. As needed, the table leaf support and the main table leaf are folded out into the deployed position such that an electrical connection is established between a power source and the power unit. Then, the device can be charged from the power unit through wireless charging. Finally, the main table leaf and the leaf support are folded back into the stowed configuration such that the electrical connection is disconnected.

### BRIEF DESCRIPTION OF THE DRAWING FIGURES

Embodiments of the invention are described in detail below with reference to the attached drawing figures, wherein:

FIG. 1 is an angled view of a wireless charging table for an aircraft in accordance with the present invention.

FIG. 2 is an angled view of a frame and a composite panel as part of a main table leaf as part of the wireless charging table of FIG. 1.

FIG. 3 is an angled view of the wireless charging table of FIG. 1 with a cover removed.

FIG. 4 is an angled view of the wireless charging table of FIG. 1 with the cover removed and shown.

FIG. 5 is a top angled view of a leaf support as part of the wireless charging table of FIG. 1.

FIG. 6 is an angled view of a bearing block as part of the wireless charging table of FIG. 1.

FIG. 7 is an angled view showing the bearing block of FIG. 6 as part of a table axle assembly as part of the wireless charging table of FIG. 1.

FIG. 8 is a bottom angled view of a portion of the leaf support of FIG. 5.

FIG. 9 is an angled view of an electrical pad as part of the wireless charging table of FIG. 1.

FIG. 10 is an angled view showing the electrical pad of FIG. 9 mounted to an upper support as part of the wireless charging table of FIG. 1.

FIG. 11 is an angled view showing the main table leaf, a power unit, and the cover removed from a leaf support as part of the wireless charging table of FIG. 1.

FIG. 12 is a method of charging an electronic device on an aircraft utilizing the wireless charging table of FIG. 1.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Aircraft are well known in the art and generally include a variety of tables and trays for use by passengers and aircraft crew (e.g., pilots). These tables and trays are commonly used to support computers and other electronic devices when in a deployed position and are configured to fold into a stowed position when not in use. The ability of the table/tray to be folded into the stowed position when not in use saves space and is also considered a safety feature. As computers and other electronic devices are commonly used in aircraft, it may be desirable to provide convenient charging of these devices.

The present invention provides for a wireless charging table that is maneuverable from a stowed configuration to a deployed configuration. In the deployed configuration, a top surface of the table is provided to support an electronic device and provide wireless charging of the electronic device. In embodiments, the stowed configuration creates an electrical disconnect such that wireless charging is not activated. In embodiments, the wireless charging table utilizes a bearing block with spring contacts for engaging with an electrical pad when the table is in the deployed position, the spring contacts being configured to disconnect from the electrical pad when the table is in the folded/stowed position. This combination of features creates the electrical connection (when deployed) for charging, and electrical disconnection (when folded/stowed).

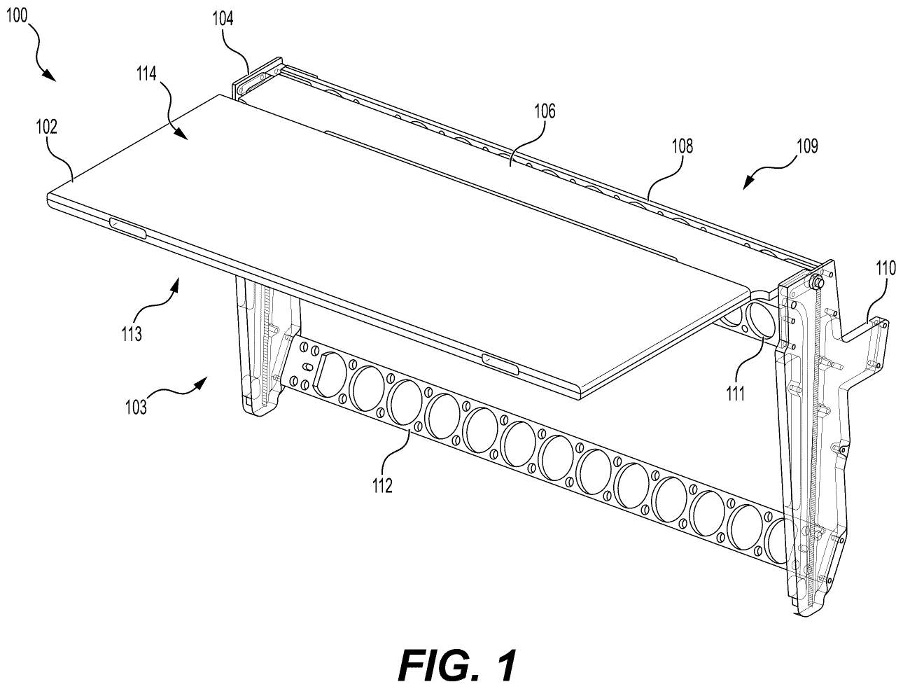

FIG. 1 shows a wireless charging table 100 for use in an aircraft. The table 100 includes a frame assembly 103 for supporting the table 100 within the aircraft. In embodiments, the table 100 is specifically a side, fold out table. The frame assembly 103 includes a first side brace 104 and a second side brace 110 with a lower support 112 extending therebetween. The side braces 104, 110 and lower support 112 may vary as would be understood by those skilled in the art and based on aircraft models. An upper support 109 also extends between the side braces 104, 110 and in embodiments includes a back upper support 108 and a front upper support 111. The front upper support 111 provides structural support for a leaf support 106 to secure to which in turn supports a main table leaf 113. The leaf support 106 and the main table leaf 113 are configured to maneuver between a stowed position and a deployed position (as shown in FIG. 1). Accordingly, the main table leaf 113 can be deployed for use, and stowed away when not in use, or as needed for safety precautions.

The main table leaf 113 includes a top surface 114 for use with a computer or other electronic device, or as desired by a user. A cover 102 is secured as a top layer of the main table leaf 113 for functional or aesthetic purposes. The cover 102 may be composed of any suitable material, as would be understood by those skilled in the art, some contemplated materials include stone, laminate, leather, wood, veneer, solid surface, etc.

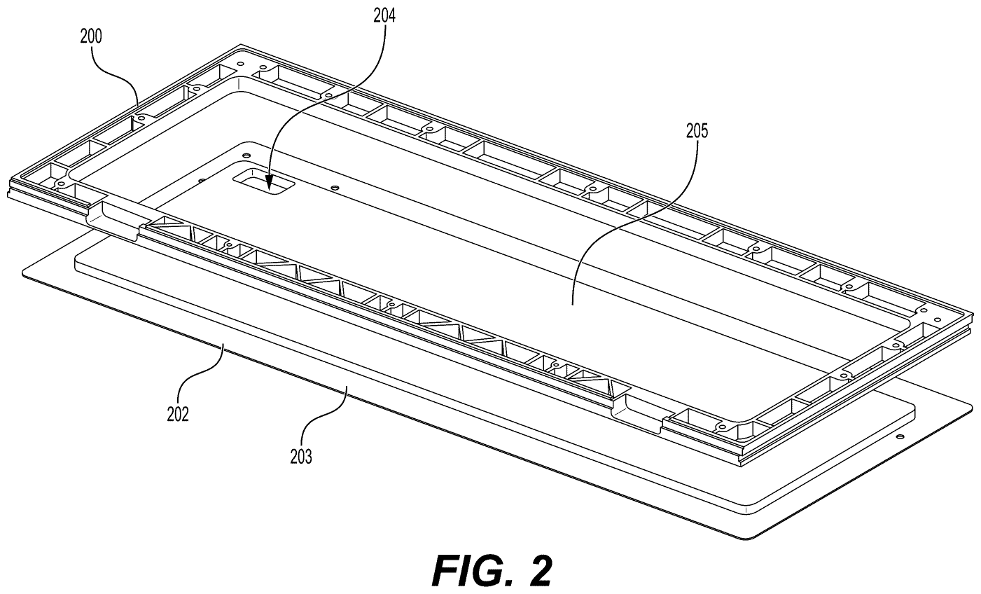

In FIG. 2, a frame 200 and a composite panel 202 as part of a main table leaf 113 are shown. The frame 200, in embodiments, is a machined aluminum frame and the composite panel 202 is bonded to the frame 200 to provide a flat surface on an underneath side. It should be appreciated that there are no wires that extend through this portion of the main table leaf 113.

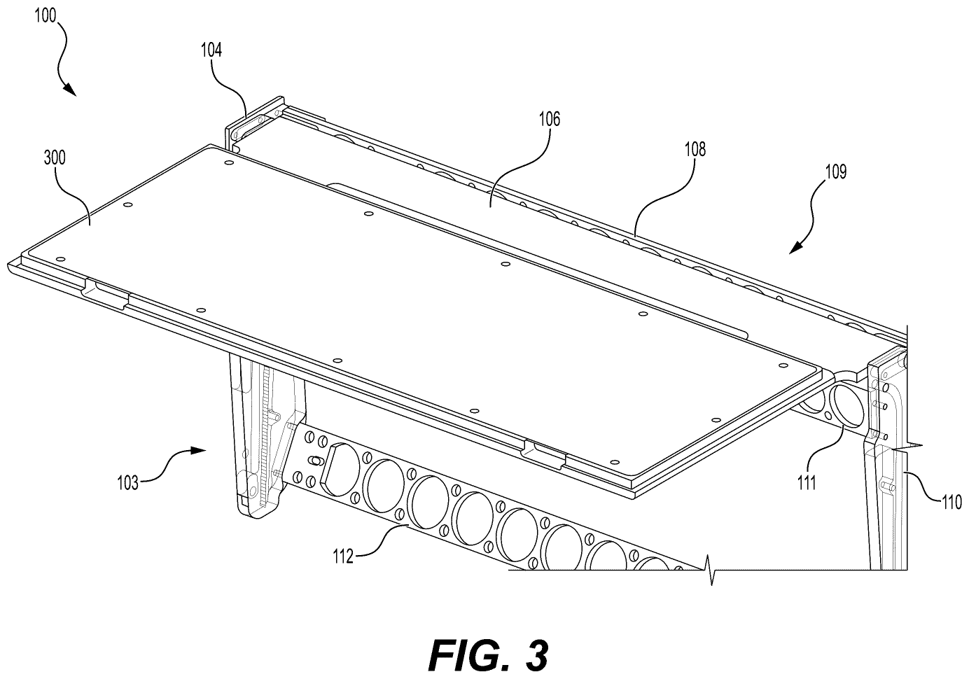

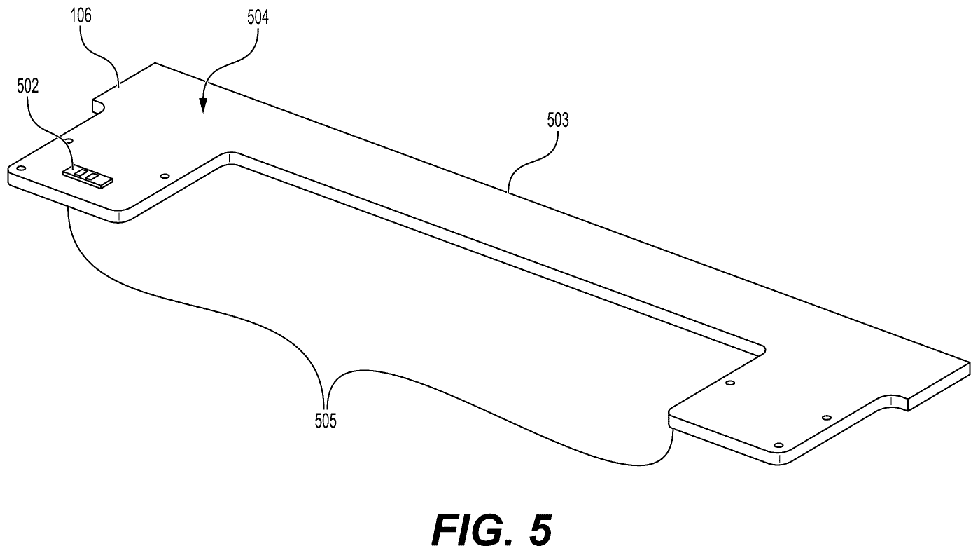

The composite panel 202 includes an outer periphery portion 203 surrounding an inner raised portion 205, wherein the frame 200 bonds to the outer periphery portion 203 such that the inner raised portion 205 extends at least partially upward within the frame 200. The frame 200, in embodiments, includes an open weave design, which may vary, but aids in reducing the overall weight of the table. The composite panel 202 is mounted to the leaf support 106 such that an opening 204 aligns with an electrical contact 502 (see FIG. 5). The electrical contact 502 provides power to a power unit 300 (see FIG. 3). As best shown in FIG. 3, the power unit 300 is mounted over the composite panel 202 and the frame 200. The power unit 300 is bolted or otherwise removably secured, which allows for the power unit 300 to be removed and replaced as needed. The power unit 300 may vary in size, power, and other functional specifics and is configurable for providing wireless charging to computers, phones, tablets, or other electronic devices as would be understood by those skilled in the art. In other words, the power unit 300 is configured such that when a computer is placed on the top surface 114, power from the power unit 300 transfers to a battery of the computer.

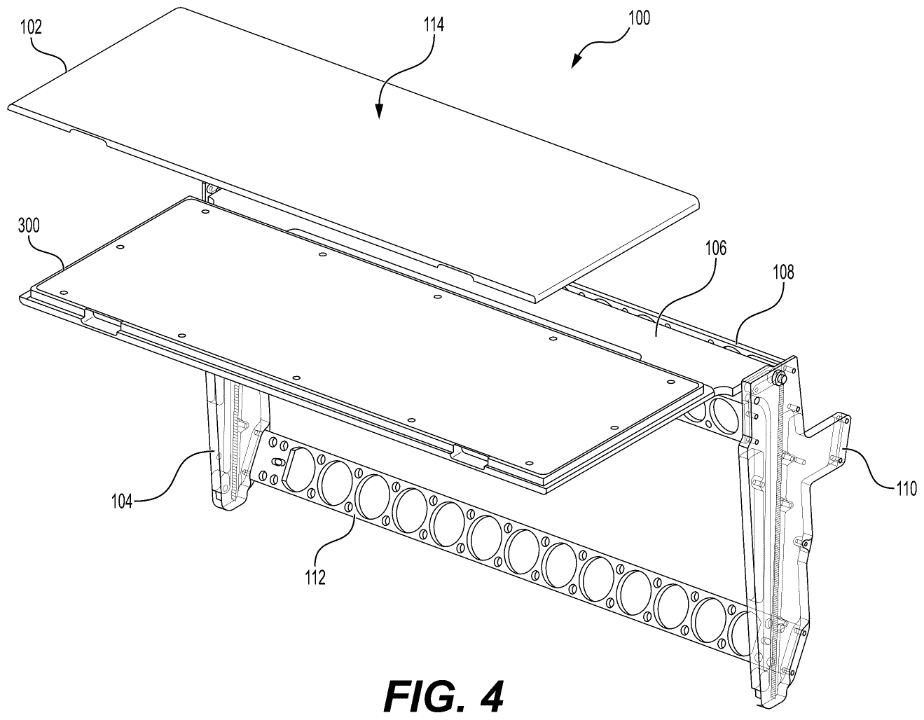

As shown in FIG. 4, the cover 102 secures over the power unit 300 such that an electrical device does not come into direct contact with the power unit 300, however, the power unit 300 is configured to provide wireless charging to an electronic device placed on top of the cover 102. Wireless charging is well known in the art, and those skilled in the art will appreciate that any known or developed technology may be employed to achieve the wireless charging result.

FIG. 5 further shows the leaf support 106 for clarity. The leaf support 106 having the electrical contact 502 presented on a top surface 504. The electrical contact 502 creates an electrical connection with the power unit 300 when the table 100 is assembled such that power can be transferred to the power unit 300. In embodiments, the leaf support 106 includes an elongated portion 503 with two extensions 505, wherein the extensions 505 are secured to and support the main table leaf 113 via bolts or similar connectors. Those skilled in the art will appreciate that the exact shape and configuration of the leaf support 106 may vary.

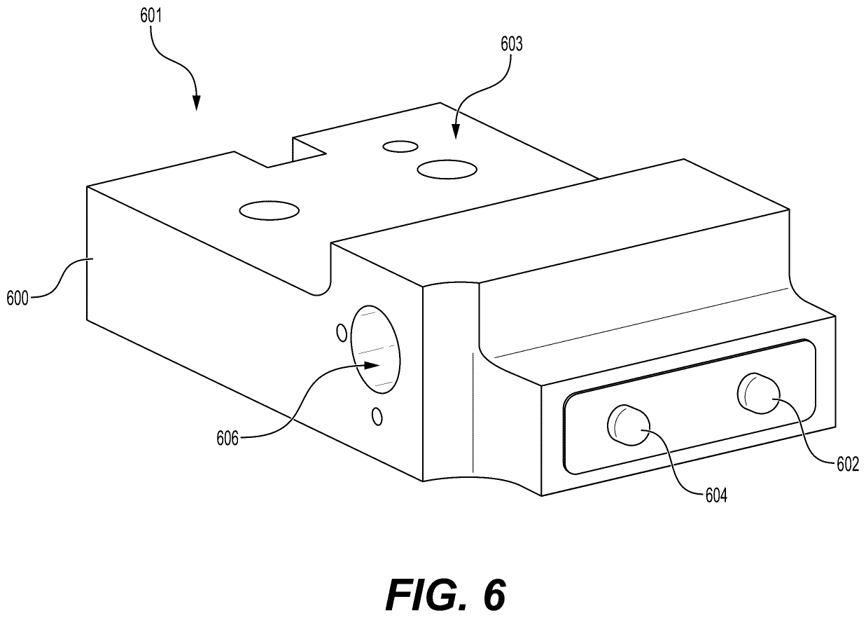

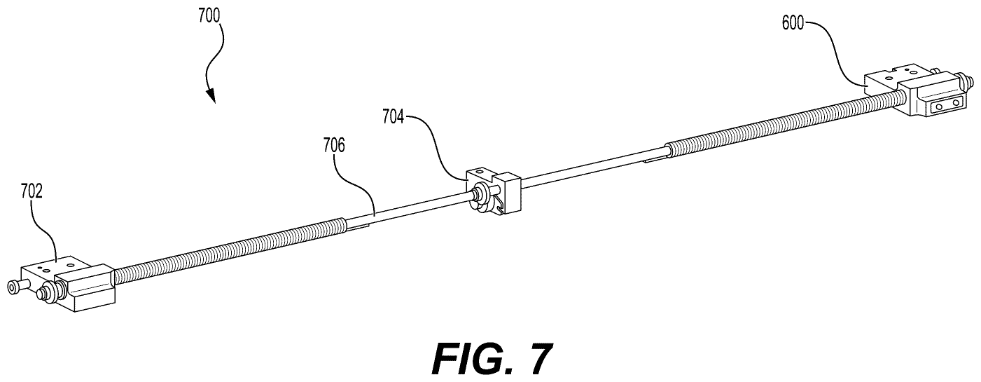

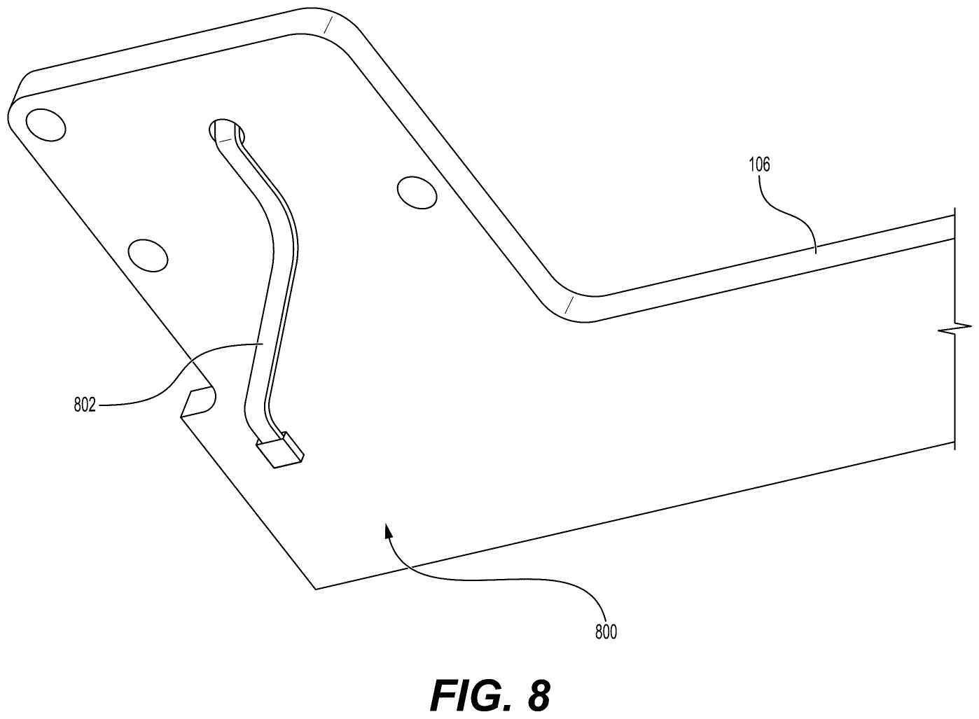

In FIGS. 6 and 7, a bearing block 600 and a table axle assembly 700 are shown. The bearing block 600 is mounted to an underneath surface 800 (see FIG. 8) of the leaf support 106, such that the bearing block 600 engages with one or more wires 802. The bearing block 600 includes a receptacle 601 for receiving the wire(s) 802 and mounts to the leaf support 106 via a surface 603 and one or more bolts or other securement means (not shown). One or more spring contacts 602, 604 extend from the bearing block 600 on the opposite end of the receptacle 601. The spring contacts 602, 604 are electrically connected to the wires 802 engaged with the receptacle 601. The bearing block 600 further includes a channel 606 that extends a width of the bearing block 600. As shown in FIG. 7, the axle assembly 700 includes the bearing block 600 as well as a non-electrical block 702 and a middle mount 704. An axle 706 extends through each of the bearing block 600, the non-electrical block 702, and the middle mount 704. The axle assembly 700 extends between the side braces 104, 110 along the underneath surface 800 of the leaf support 106. The axle assembly 700 moves with the leaf support 106 between the stowed and deployed configurations.

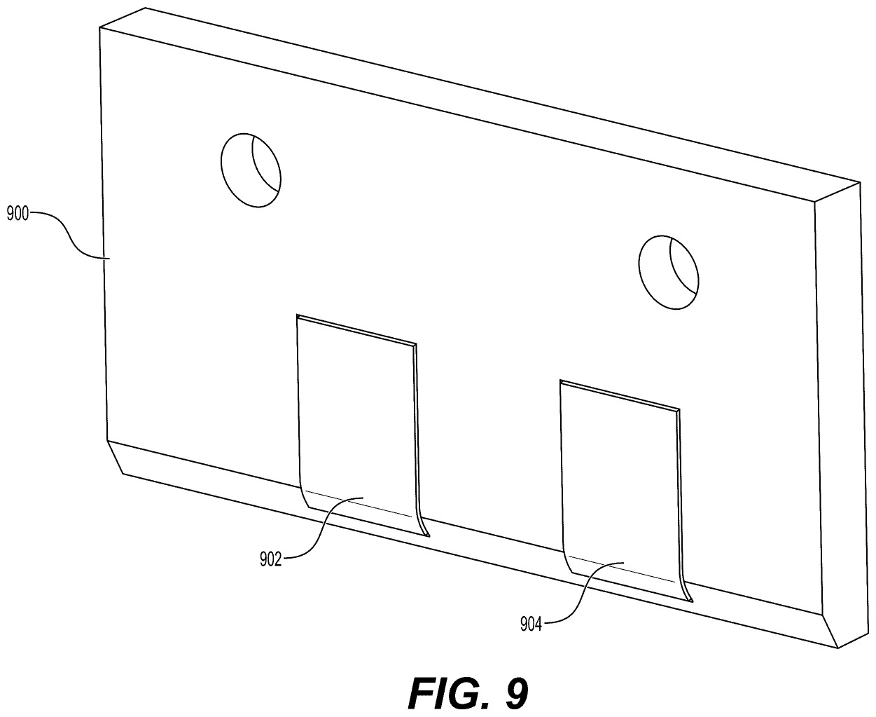

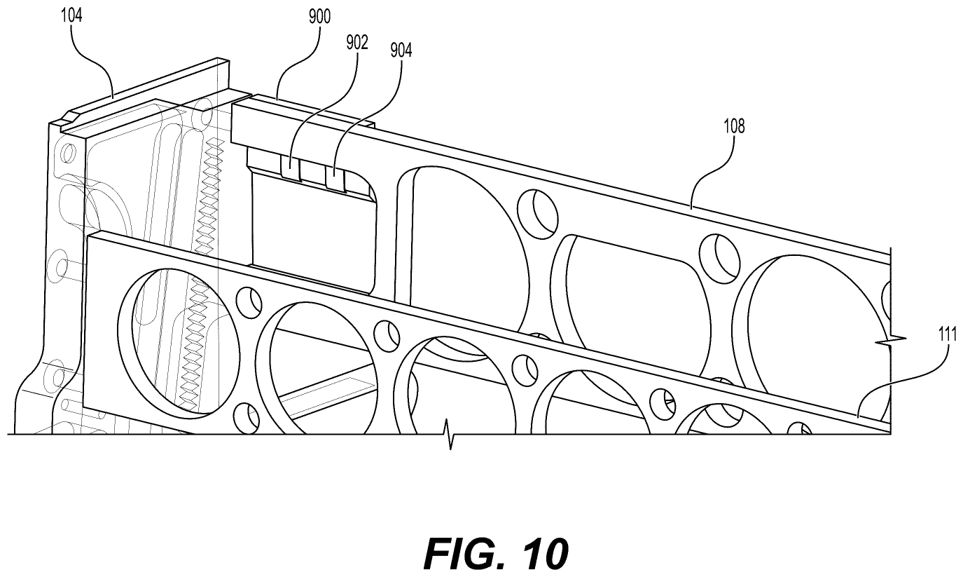

Due to the position of the bearing block 600 when mounted to the leaf support 106, the spring contacts 602, 604 connect with the contacts 902, 904 of an electrical pad 900, shown in FIG. 9. Specifically, as shown in FIG. 10, the electrical pad 900 is mounted to the back upper support 108 via any means reasonable within the art, such as bolts, screws, adhesives, or similar devices, with the contacts 902, 904 positioned to connect with the spring contacts 602, 604 when the table 100 is in the deployed position. The electrical pad 900 is further electrically coupled to a power source, such that power drawn from the power source is transmitted through the electrical pad 900. In other words, when the table 100 is deployed, the leaf support 106 will move toward the back upper support 108, such that the bearing block 600 moves to a position adjacent to the electrical pad 900 and the spring contacts 602, 604 complete an electrical connection with the electrical pad 900 via contacts 902, 904. The use of spring contacts 602, 604 help prevent a disconnect such as during turbulence of the aircraft. Further, when the table 100 is in the stowed configuration, the leaf support 106 moves away from the electrical pad 900 and the back upper support 108, thereby creating an electrical disconnect, removing power transmittance to the power unit 300.

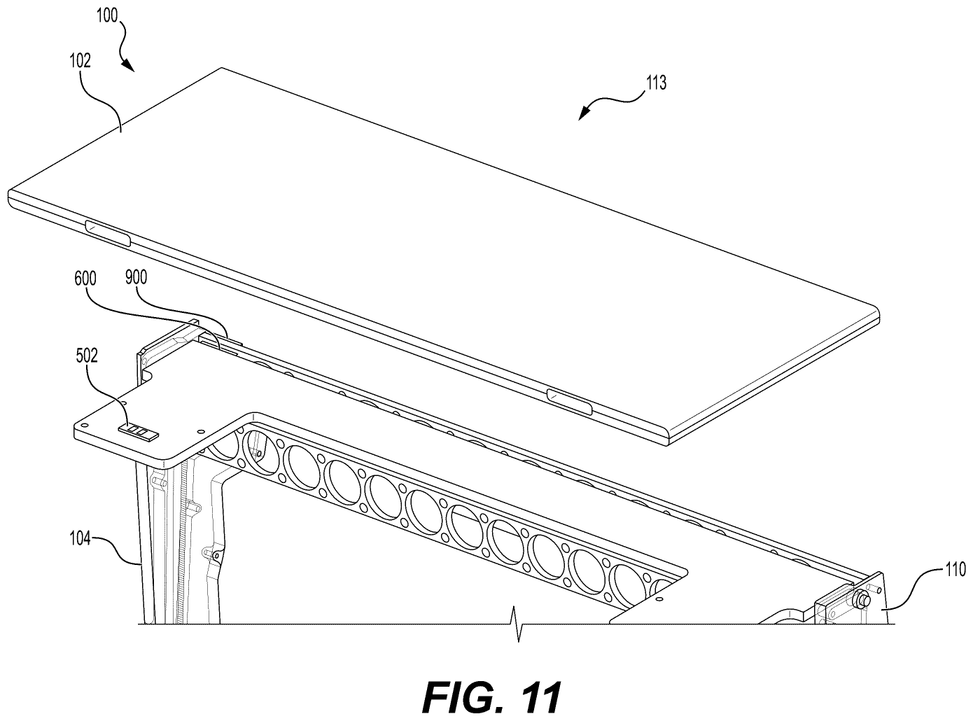

FIG. 11 shows the leaf support 106 in the deployed position. As shown, the electrical pad 900 becomes positioned adjacent to the bearing block 600 such that the spring contacts 602, 604 (not shown in FIG. 11) and electrical pad contacts 902, 904 (not shown in FIG. 11) are connected and complete an electrical connection to the electrical contact 502 via the one or more wires 802. In other words, when in the deployed position, the electrical pad 900 is connected to the bearing block 600, the bearing block 600 is connected to the wires 802, the wires 802 are connected to the electrical contact 502, and the electrical contact 502 is connected to the power unit 300. Accordingly, the power unit 300 can be used for wireless charging. When not in use, this electrical connection is broken, which reduces the use of power and also reduces the length and use of wires, which can become tangled and/or create snagging hazards.

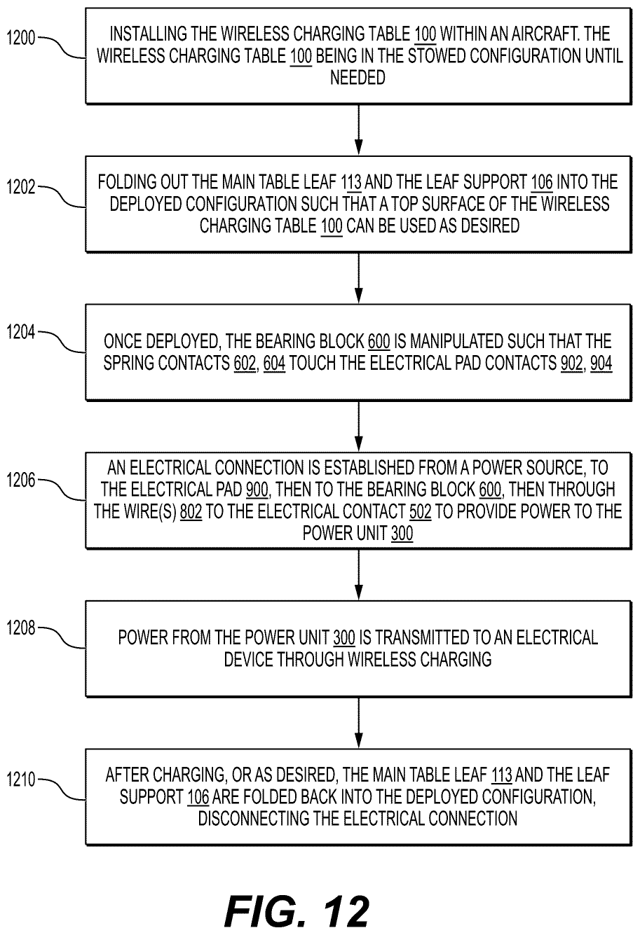

In FIG. 12, a flowchart depicts a method of charging an electrical device. At step 1200, the wireless charging table 100 is installed within an aircraft and stored in the stowed configuration until needed. Installing of the wireless charging table 100 will conventionally happen during aircraft manufacturing, but it is contemplated that after manufacturing installation is possible. At step 1202, the main table leaf 113 along with the leaf support 106, fold into a deployed configuration such that a top surface of the wireless charging table 100 can be used as desired, such as for a table or for charging a device. At steps 1204 and 14206, once deployed, the bearing block 600 is manipulated such that the spring contacts 602, 604 touch the electrical pad contacts 902, 904. This creates the needed electrical connection for wireless charging. Specifically, an electrical connection is then established from a power source (not shown) to the electrical pad 900, then to the bearing block 600, then through the wire(s) 802 to the electrical contact 502. The electrical contact 502 then provides power to the power unit 300.

At step 1208, as a user places an electrical device on the table, wireless charging from the power unit 300 to the electrical device is accomplished. Wireless charging is known in the art and can utilize any of the necessary technology.

At step 1210, as desired or as needed, the main table leaf 113 and the leaf support 106 are folded back into the deployed configuration, wherein the electrical connection becomes disconnected, and no power is transmitted to the power unit 300. Specifically, the spring contacts 602, 604 disconnect from the electrical pad contacts 902, 904 breaking the electrical connection.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A wireless charging table for use in an aircraft, the wireless charging table comprising:
a frame assembly for mounting the wireless charging table within the aircraft;
a table leaf support coupled to the frame assembly and maneuverable between a stowed position and a deployed position;
a main table leaf mounted to the table leaf support and having a power unit; and
an electrical system configured to provide power to the power unit when the table leaf support is in the deployed position;
wherein, when the table leaf support is in the deployed position, an electrical connection is established between a power source and the power unit and when the table leaf support is in the stowed position, the electrical connection is broken between the power source and the power unit;
wherein the power unit is configured to provide wireless charging to one or more devices when the electrical connection is established.

2. The wireless charging table of claim 1, wherein the electrical system further comprises:
an electrical contact presented on a top surface of the table leaf support and connected to at least one wire, the at least one wire travels along a bottom surface of the table leaf support;
a bearing block mounted to the table leaf support and in electrical contact with the at least one wire, the bearing block having one or more electrical contacts; and
an electrical pad mounted to the frame assembly and configured to electrically couple to the bearing block via the one or more electrical contacts;
wherein, when the table leaf support is in the deployed configuration, the one or more electrical contacts of the bearing block connect with the electrical pad to establish the electrical connection.

3. The wireless charging table of claim 2, wherein the one or more electrical contacts are spring contacts.

4. The wireless charging table of claim 2, wherein the bearing block is part of a table axle assembly that extends substantially between a first side brace and a second side brace of the frame assembly.

5. The wireless charging table of claim 4, wherein the table axle assembly further comprises a non-electrical block, a middle mount, and an axle that extends through the bearing block, the non-electrical block, and the middle mount.

6. The wireless charging table of claim 2, wherein the bearing block further comprises:
a substantially flat surface for abutting to the bottom surface of the table leaf support;
a receptacle on a first end of the bearing block for receiving the at least one wire to create an electrical connection between the bearing block and the electrical contact;
a channel through which an axle can extend; and
the electrical contacts extending from a second end, the second end being substantially opposite of the first end.

7. The wireless charging table of claim 1, wherein the main table leaf further comprises a composite panel supported by a machined aluminum frame and the power unit is mounted to the machined aluminum frame.

8. The wireless charging table of claim 7, wherein the composite panel further comprises an opening through which the power unit is connected to an electrical contact as part of the electrical system.

9. The wireless charging table of claim 1, further comprising a cover for securing over a top surface of the power unit.

10. The wireless charging table of claim 9, wherein the cover is composed of a material selected from a group consisting of leather, stone, laminate, wood, and veneer.

11. A method of charging a device on an aircraft, the method comprising:
providing a wireless charging table, having:
a frame assembly for mounting the wireless charging table within the aircraft;
a table leaf support coupled to the frame assembly and maneuverable between a stowed position and a deployed position;
a main table leaf mounted to the table leaf support and having a power unit; and
an electrical system configured to provide power to the power unit when the table leaf support is in the deployed position;
folding out the table leaf support and the main table leaf into the deployed position such that an electrical connection is established between a power source and the power unit;
charging the device from the power unit through wireless charging; and
folding the main table leaf and the leaf support back into the stowed configuration such that the electrical connection is disconnected.

12. The method of claim 11, wherein the electrical system further comprises:
an electrical contact presented on a top surface of the table leaf support and connected to at least one wire, the at least one wire travels along a bottom surface of the table leaf support;
a bearing block mounted to the table leaf support and in electrical contact with the at least one wire, the bearing block having one or more electrical contacts; and
an electrical pad mounted to the frame assembly and configured to electrically couple to the bearing block via the one or more electrical contacts;
wherein, when the table leaf support is in the deployed configuration, the one or more electrical contacts of the bearing block connect with the electrical pad to establish the electrical connection.

13. The method of claim 12, wherein the one or more electrical contacts are spring contacts.

14. The method of claim 12, wherein the bearing block is part of a table axle assembly that extends substantially between a first side brace and a second side brace of the frame assembly.

15. The method of claim 14, wherein the table axle assembly further comprises a non-electrical block, a middle mount, and an axle that extends through the bearing block, the non-electrical block, and the middle mount.

16. The method of claim 12, wherein the bearing block further comprises:
a substantially flat surface for abutting to the bottom surface of the table leaf support;
a receptacle on a first end of the bearing block for receiving the at least one wire to create an electrical connection between the bearing block and the electrical contact;
a channel through which an axle can extend; and
the electrical contacts extending from a second end, the second end being substantially opposite of the first end.

17. The method of claim 11, wherein the main table leaf further comprises a composite panel supported by a machined aluminum frame and the power unit is mounted to the machined aluminum frame.

18. The method of claim 17, wherein the composite panel further comprises an opening through which the power unit is connected to an electrical contact.

19. The method of claim 11, further comprising a cover for securing over a top surface of the power unit.

20. The method of claim 19, wherein the cover is composed of a material selected from a group consisting of leather, stone, laminate, wood, and veneer.
